(19) United States
(12) Patent Application Publication
(10) Pub. No.: US 2002/0021075 A1
(43) Pub. Date: Feb. 21, 2002

(54) Electron gun, cathode ray tube and image display device

(76) Inventors: Hirofumi Nakamura, Aichi (JP); Hideki Miyazaki, Aichi (JP); Keizo Mori, Aichi (JP); Kouji Shibusa, Aichi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 09/885,009

(22) Filed: Jun. 21, 2001

(30) Foreign Application Priority Data
Jun. 26, 2000 (JP) P2000-191340
May 11, 2001 (JP) P2001-141112

(51) Int. Cl. H01J 29/50

(52) U.S. Cl. 313/412

(57) ABSTRACT

To provide an electron gun that can improve the focus characteristics of a cathode ray tube by reducing the working area of the cathode, a cathode ray tube equipped with this electron gun that has favorable focus characteristics, and an image display device comprising this cathode ray tube that can achieve favorable images. An area on the electron emission surface of the cathode K that meets the beam hole (11A) of the first grid (11) forms an electron gun in closest proximity to the first grid (11). Provide a cathode ray tube equipped with this electron gun and further provide an image display device formed by this cathode raytube.

### BACKGROUND OF THE INVENTION

1. Field of the Invention

The present invention relates to an electron gun, a cathode ray tube equipped with an electron gun, and an image display device comprising a cathode ray tube.

1. Description of the Related Art

In electron guns used for cathode ray tubes electrons are drawn out from a cathode to form an electron beam by means of impregnating (namely, an equipotential line curves towards the cathode side) an electric field from a first grid towards the cathode.

Hereupon, when attempting to improve the focus characteristics of an electron gun, reducing the working area formed on the cathode surface, namely the range wherein electrons are drawn out, has been considered.

Conventionally, a method to reduce the working area and improve the emittance has generally been to reduce the diameter of the beam hole of a first grid opposite the cathode.

However, the beam hole diameter of the first grid in electron guns used in recent high resolution cathode ray tubes has been considerably reduced up to 0.3 mm.

Consequently, forming the area around the beam hole of the first grid using a mold in an precision process has become very difficult. This has made it necessary to perform precision alignment using an assembly tool for the relative positioning between the first grid and second grid.

Therefore, there are limits in improving the focus characteristics in a method that reduces only the diameter of the beam hole of the first grid more than this.

Furthermore, there is another problem in which the drive voltage must be increased if the diameter of the beam hole of the first grid is reduced smaller than this. Generally there is a problem of poor tracking of the drive voltage when operating at high frequencies due to increased drive voltage.

For this case, narrowing the distance between the cathode and the first grid in order to prevent the drive voltage from increasing has been considered.

Narrowing the distance between the cathode and the first grid more than this amount however, resulted in reliability problems. Namely, as the distance narrowed a problem surfaced in which it became easier for the cathode and the first grid to make contact.

Even further, because the surface of a conventional cathode is flat, the impregnation of an electric field at the center of the cathode is gradual.

Consequently, the working area is widened. Thus, in a conventional cathode, it is difficult to further improve the focus characteristics in a high resolution cathode ray tube.

In addition, a cathode that limits the emission region, namely, a limiting cathode is already provided.

However, even though the working area reaches the emission limit region when this type of limiting cathode is used in a high resolution cathode ray tube, a problem of the drive curve losing its linearity still occurs.

For this case, there was a problem of the emission of electrons from the end of the emission limit region becoming unstable and worsening the focus.

### SUMMARY OF THE INVENTION

In order to solve the above-mentioned problems, the present invention provides an electron gun that can improve the focus characteristics of a cathode ray tube by reducing the working area of the cathode, a cathode ray tube equipped with this electron gun that has favorable focus characteristics, and an image display device comprising this cathode ray tube that can achieve favorable images.

The electron gun of the present invention is comprised of a cathode that has an electron emission surface and a first grid that has a beam hole.

The electron emission surface and the beam hole are opposite each other and the area opposite the beam hole within the electron emission surface is in closest proximity to the first grid.

The cathode ray tube of the present invention is equipped with an electron gun. This electron gun is comprised of a cathode that has an electron emission surface and a first grid that has a beam hole.

The electron emission surface and the beam hole are opposite to each other and the area opposite the beam hole within the electron emission surface is in closest proximity to the first grid.

The image display device of the present invention is equipped with a cathode ray tube.

This cathode ray tube is equipped with an electron gun.

This electron gun is comprised of a cathode that has an electron emission surface and a first grid that has a beam hole.

and the beam hole are opposite to each other and of the electron emission surface the area opposite the beam hole within the electron emission surface is in closest proximity of the first grid.

According to the composition of the electron gun of the present invention described above, the area within the electron emission surface of the cathode being opposite to the beam hole of the first grid is in closest proximity to the first grid. As an electric field is concentrated at this area in closest proximity to the first grid, so the working area of the cathode can be reduced.

According to the composition of the cathode ray tube of the present invention described above, by means of equipping the cathode ray tube with the electron gun, the working area of the cathode is reduced which in turn reduces crossover of the electron beam. Consequently, the beam spot on the fluorescent surface is also reduced.

According to the composition of the image display device of the present invention described above, by means of comprising the display device by the cathode ray tube, the beam spot is reduced improving the focus characteristics to obtain clear images.

### BRIEF DESCRIPTION OF THE DRAWINGS

FIG. 1 is a schematic compositional view of a color cathode ray tube to which the present invention is applied;

FIG. 2 is a schematic compositional view of an electron gun used for the color cathode ray tube of FIG. 1;

FIG. 3 is an enlarged cross sectional view of a cathode of the electron gun and an area around a first grid in an embodiment of the present invention;

FIG. 4 is a schematic diagram showing a trajectory of an electron beam of the electron gun comprising the cathode and a structure of the first grid illustrated in FIG. 3;

FIG. 5A shows a diagram obtained by simulating the size of a working area of a conventional cathode with a flat electron emission surface;

FIG. 5B shows a diagram obtained by simulating the size of a working area of the cathode shown in FIG. 3;

FIG. 6A is a cross sectional view of the structure of the cathode and an area in the vicinity of the first grid showing an example of another embodiment of the present invention in which the electron emission surface of the cathode becomes convex on the first grid side;

FIG. 6B is a cross sectional view of the structure of the cathode and an area in the vicinity of the first grid showing an example of further another embodiment of the present invention in which the electron emission surface of the cathode becomes convex on the first grid side;

FIG. 6C is a cross sectional view of the structure of the cathode and an area in the vicinity of the first grid showing an example of still further another embodiment of the present invention in which the electron emission surface of the cathode becomes convex on the first grid side;

FIG. 7 is a cross sectional view of the structure of the cathode and an area in the vicinity of the first grid showing another embodiment of the present invention in which the first grid side becomes convex on the cathode side; and

FIG. 8 is a cross sectional view showing the arrangement of three cathodes and a first grid when applying the composition of FIG. 7 to a color electron gun for cathode ray tube generating three electron beams.

### DESCRIPTION OF THE PREFERRED EMBODIMENTS

The present invention is related to an electron gun comprised of cathode that has an electron emission surface and a first grid that has a beam hole.

The electron emission surface and the beam hole are arranged opposite to each other.

The area opposite the beam hole within the electron emission surface is in closest proximity to the first grid.

Further, the present invention has a composition wherein the electron emission surface of the cathode forms a convex surface on the first grid in the above-mentioned electron gun.

The present invention is a cathode ray tube equipped with the electron gun.

This electron gun is comprised of a cathode that has an electron emission surface and a first grid that has a beam hole.

The electron emission surface and the beam hole are arranged opposite to each other.

Furthermore, the area opposite the beam hole within the electron emission surface is in closest proximity to the first grid.

The present invention has a composition wherein the electron emission surface of the cathode forms a convex surface on the first grid in the above-mentioned cathode ray tube.

The present invention is an image display device equipped with a cathode ray tube.

This cathode ray tube is equipped with an electron gun.

This electron gun is comprised of a cathode that has an electron emission surface and a first grid that has a beam hole.

The electron emission surface and the beam hole are arranged opposite to each other.

The area opposite the beam hole within the electron emission surface is in closest proximity to the first grid.

The present invention has a composition wherein the electron emission surface of the cathode forms a convex surface on the first grid in the above-mentioned image display device.

FIG. 1 is a schematic compositional view of a color cathode ray tube using the present invention.

The color cathode ray tube 1 is comprised of a body 2 formed of glass. The body 2 has a panel 2a, a funnel 2b and a neck 2c

A fluorescent material is applied to the inside surface of the panel 2a of the body 2 to form a fluorescent surface 4. An electron gun is also disposed inside the neck 2c of the body 2.

Three electron beams R, G. B are emitted from a electron gun 10. While these three electron beams R, G, B are focused, they pass through electron beam through holes 6 of an grid thin panel for color selection mechanism 5 disposed in front of and opposite to the fluorescent surface 4 irradiating the fluorescent surface 4.

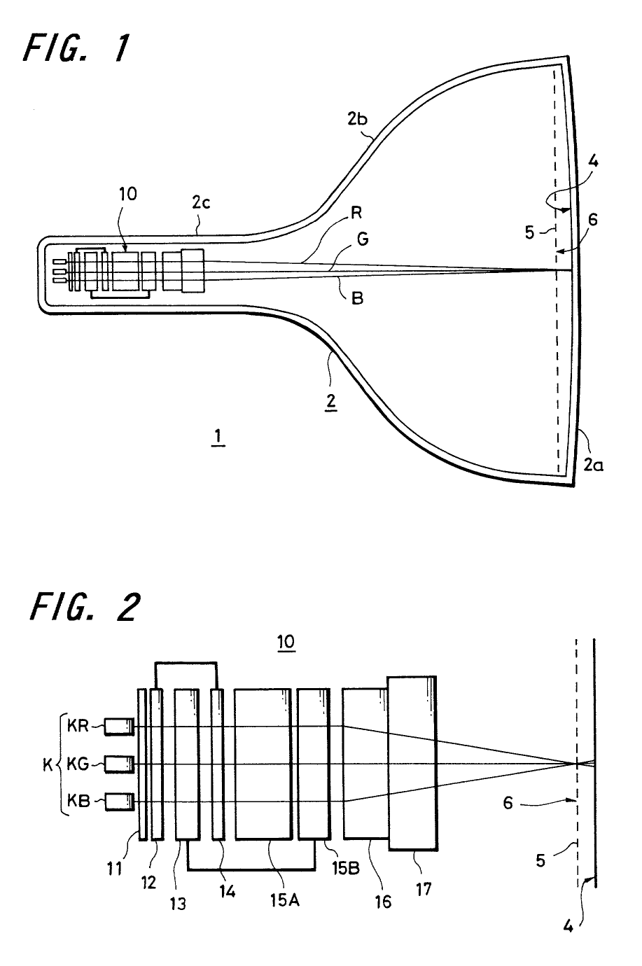

A schematic compositional view of the electron gun 10 of FIG. 1 is shown in FIG. 2.

This electron gun 10 has three inline arranged cathodes KR, KG, KB. A first grid 11, second grid 12, third grid 13, fourth grid 14, fifth grid, sixth grid 16, and a shield cup 17 are arranged in this sequence coaxially away from these cathodes K (KR, KG, KB) towards the anode side.

The second grid 12 and the fourth grid 14 are electrically connected to achieve continuity.

The fifth grid, equivalent to a focus grid, is divided into two parts, a #1 fifth grid 15A that forms a first focus grid and a #2 fifth grid 15B that forms a second focus grid.

Moreover, the third grid and the #2 fifth grid 15B are electrically connected to achieve continuity.

A voltage of, for example, 0 V (or a few tens of volts) is applied to the first grid 11, a voltage of, for example, 200-800 V is applied to the second grid 12 and the fourth grid 14, and an anode voltage of, for example, 22 kV˜30 kV is applied to the sixth grid 16.

In addition, a fixed focus voltage is applied to the third grid 13 and the anode side of the #2 fifth grid 15B of the divided fifth grid.

In contrast, a dynamic voltage is applied to the cathode K side of the #1 fifth grid 15A of the divided fifth grid.

By means of applying these voltages, a quadrupole lens (not shown in figure) is formed between the #1 fifth grid 15A and the #2 fifth grid 15B and in addition, this quadrupole lens can bring about changes in the strength of the principal lens (focus lens: not shown in figure) formed between the #2 fifth grid 15B and the sixth grid 16.

As a result, a favorable spot shape of the electron beam can be obtained on the periphery of the fluorescent surface in the horizontal direction.

Thermoelectrons emitted from the cathode K are accelerated and focused by means of passing through each grid 11˜16 of the electron gun 10. Then, these thermoelectrons pass through specified electron beam through holes 6 of the grid thin panel for color selection 5 and then converge on the fluorescent surface 4.

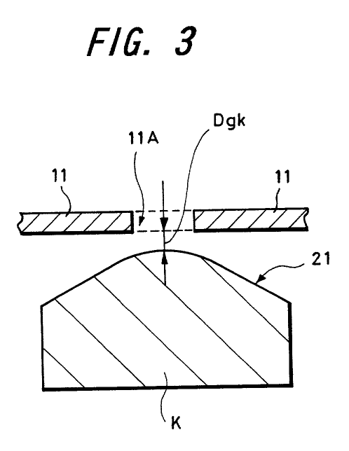

Hereupon, FIG. 3 shows an enlarged cross sectional view of the cathode K in the grid gun 10 of FIG. 2 and the area around the first grid 11 as an embodiment of the present invention.

In this embodiment, the surface 21 of the cathode K in particular is a dome shape that has a swelled curved convex shape on the first grid 11 side.

Consequently, the area, namely the center area, on the surface 21 that forms the electron emission surface of the cathode K that meets the opening 11A of the first grid 11 is in closest proximity to the first grid 11.

In other words, the distance Dgk between the first grid 11 and the cathode K is made as close as possible at the center area of the surface 21 of the cathode K shown in FIG. 3. Moreover, the cathode K is gradually separated from first grid 11 the more it moves towards the outside.

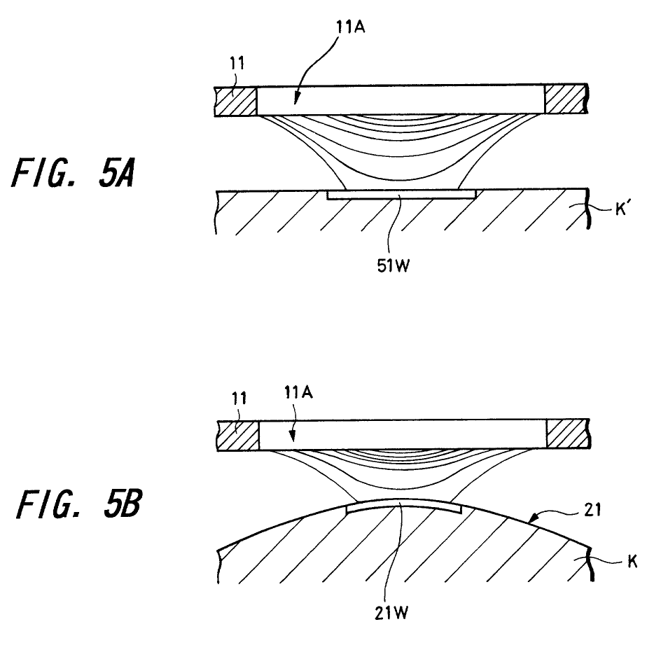

Because of this, an electric field can be concentrated at the center area of the surface 21 of the cathode K thereby making it possible to reduce the region where electron emission occurs by means of the working area 21W (refer to FIG. 5), namely, due to an electric field being formed around the surface 21 of the cathode K.

Because crossover can be reduced by reducing the working area 21W in this manner, both the emittance and the focus characteristics can be improved.

Either an impregnation type cathode or an oxide type cathode can be used for the cathode K.

For an impregnation type cathode, a high melting point metal such as tungsten or molybdenum can be pressed into a fine powder, this powder then formed into a dome-shaped disk, an electron emission material impregnated into the disk to finally create a dome-shaped cathode.

The pressed disk can also be shaved and formed into a dome shape, after which an electron emission material is impregnated into the disk to finally create a dome-shaped cathode.

Curved surfaces whereon, for example, a spherical surface or cross section form of a parabola or a combination of these curved surfaces and circular cone shapes can be considered for the shape of the dome that comprises the surface 21 of the cathode K.

Furthermore, the curvature of the surface 21 of the cathode K can be made to produce an astigmatic effect by changing the aspect ratio (ratio between the horizontal direction which is in the left and right direction of FIG. 5 and the vertical direction which is in the direction perpendicular to the paper surface of FIG. 5) to a value other than 1.

In other words, an astigmatic effect can be produced by means of making the curvature of the electron emission surface of the cathode K different using the direction. This makes it possible to improve the shape of the spot of the electron beam even more.

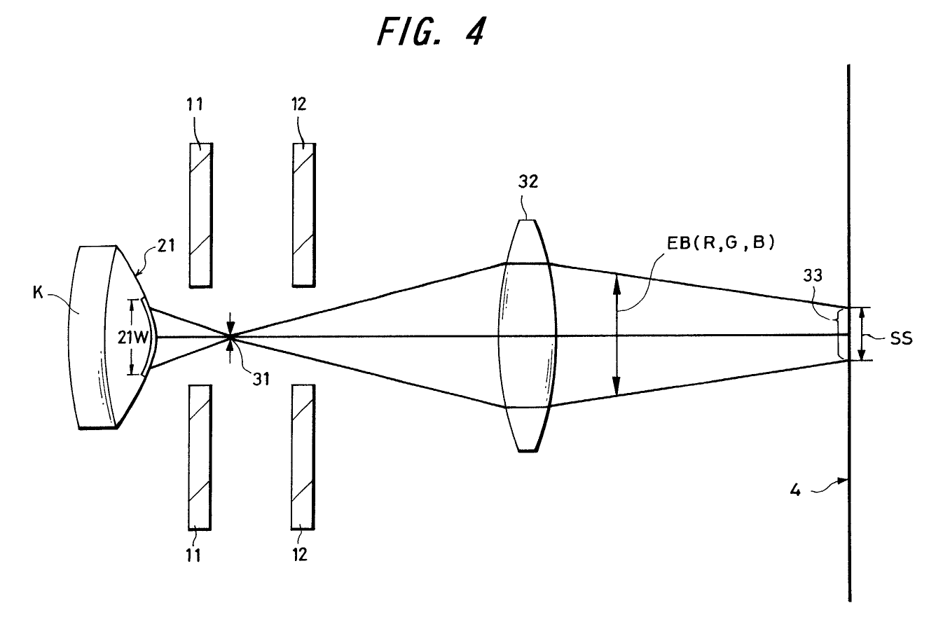

FIG. 4 shows a schematic diagram showing the trajectory of the electron beam in the composition of FIG. 3.

As shown in FIG. 4, after narrowing the electron beam EB (either R, G or B in FIG. 1 which are emitted from the working area 21W of the surface 21 of the cathode K) at a crossover 31 formed around the first grid 11 and the second grid 12 along the trajectory of the electron beam, the electron beam is concentrated by a principal lens 32 and link a beam spot 33 on the fluorescent surface 4. In the figure SS indicates the spot size of the beam spot 33.

Hereupon, a simulation was carried out to compare size of the working area on a conventional flat cathode and the cathode K that has the dome-shaped surface 21 of FIG. 3. The simulation conditions were as follows:

Diameter of the beam hole 11A of the first grid 11: 0.3 mm

Drive voltage: 40 V

The results of the simulation are shown in FIG. 5.

The surface area (0.049 mm²) of the working area 21W of the cathode K in the composition of FIG. 3 was compared to the surface area (0.066 mm²) of the working area 51W of a conventional flat cathode K′ and a reduction of approximately 25% was confirmed.

Furthermore, the center area of the cathode K can be tapered off from the curved surface of the dome shape even more to form a circular cone shape. This makes it possible to concentrate the electric field more which in turn reduces the crossover and improves the focus characteristics.

Incidentally, when using an impregnation type cathode as the cathode, normally, Ir, Os, Ru and Sc is sputtered onto the cathode surface in order to make the work function of the cathode surface smaller.

Thereupon, the emission emitting region can be limited by means of reducing the region where the sputter is performed smaller than the diameter of the beam hole 11A of the first grid 11.

It is possible to increase the emission limiting effect even further as well as improve the focus characteristics more by means of applying the method to limit this sputter region to the cathode K or a circular cone-shaped cathode which have the above-mentioned dome-shaped surface 21.

Further, a method that limits this emission emitting region can also be combined in like manner to cathodes other than impregnation type cathodes, for example, oxide type cathodes.

According to the embodiment described above, because the surface 21 of the cathode K is a dome type and the center area on the surface 21 that forms the electron emission surface of the cathode K that meets the beam hole 11A of the first grid 11 is in closest proximity to the first grid 11, an electric field can be concentrated at the center area of the surface 21 of the cathode K making it possible to reduce the working area 21W.

This increases the current density at the center area of the electron beam EB (R, G, B), reduces the crossover 31, improves the emittance and reduces spot size SS of the electron beam on the fluorescent surface 4.

Consequently, a sharper beam spot 33 can be obtained thereby improving the focus characteristics of the cathode ray tube.

Because the focus characteristics of the cathode ray tube are improved, clear images with favorable focus can be obtained in the display device comprising the cathode ray tube.

In particular, the focus characteristics are improved making it possible to obtain clear images when using this invention in a high-resolution image display device comprising a cathode ray tube.

Furthermore, according to this embodiment, because the surface 21 of the cathode K is a dome shape, when an area other than the center area that forms the working area 21W moves back towards the first grid 11 making the distance Dgk between the cathode K and the first grid 11 smaller, factors which lead to losses in reliability such as leaks and contact between the cathode K and the first grid 11 do not occur even if the cathode K slants.

Because of this, the distance Dgk between the cathode K and the first grid 11 is tightened even further allowing the drive voltage to be reduced while maintaining reliability.

Therefore, the drive voltage can be reduced making it possible to obtain favorable tracking of the drive voltage when operating at high frequencies.

Even further, because the surface of the cathode K forms a gentle curved surface, there is an advantage of being able to cover a certain concentric shift between the beam hole 11A of the first grid 11 for concentric settings of the first grid 11 and the cathode K compared to a case when the end of the cathode K is a circular cone shape.

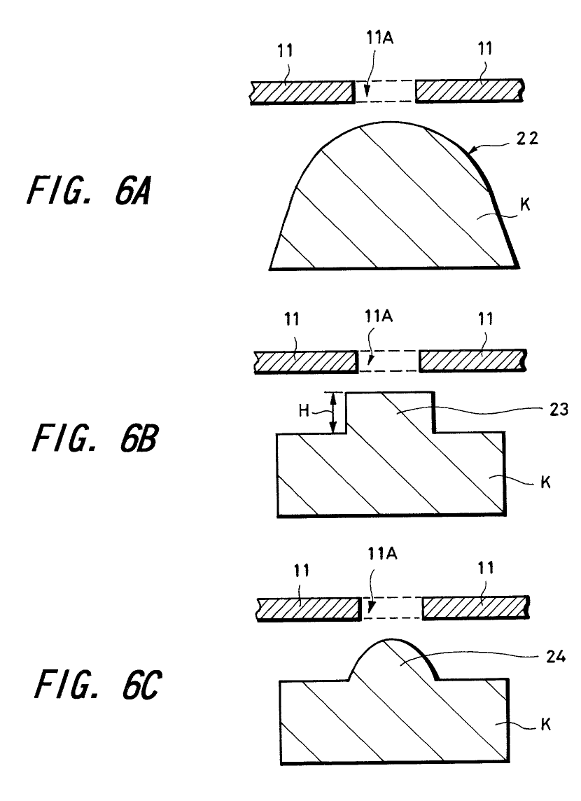

Continuing, FIG. 6A˜FIG. 6C show another shape of the surface of the cathode K in another embodiment of the present invention.

FIG. 6A shows the surface 22 of the cathode K as a parabola surface.

For this case, because the center area on the surface 22 that forms the electron emission surface of the cathode K that meets the beam hole 11A of the first grid 11 is in closest proximity to the first grid 11, an electric field can be concentrated at this center area making it possible to reduce the working area in the same manner as the first embodiment described above.

FIG. 6B shows when the center area 23 of the cathode K opposite the beam hole 11A of the first grid 11 is in proximity to the first grid 11 and another portion provides a level difference H away from the first grid 11.

For this case as well, because the center area 23 on the surface that forms the electron emission surface of the cathode K that meets the beam hole 11A of the first grid 11 is in closest proximity to the first grid 11, an electric field can be concentrated at this center area 23 making it possible to reduce the working area in the same manner as the first embodiment described above.

FIG. 6C shows when the center area 24 of the cathode K opposite the beam hole 11A of the first grid 11 is a dome shape and is in proximity to the first grid 11 and another portion is moved away from the first grid 11.

For this case as well, because the dome-shaped center area 24 on the surface that forms the electron emission surface of the cathode K that meets the beam hole 11A of the first grid 11 is in closest proximity to the first grid 11, an electric field can be concentrated at-this dome-shaped center area 24 making it possible to reduce the working area in the same manner as the first embodiment described above.

Therefore, in these FIGS. 6A˜6C, the working area can be reduced, the spot size can be reduced and the focus characteristics improved in the same manner as the first embodiment described above.

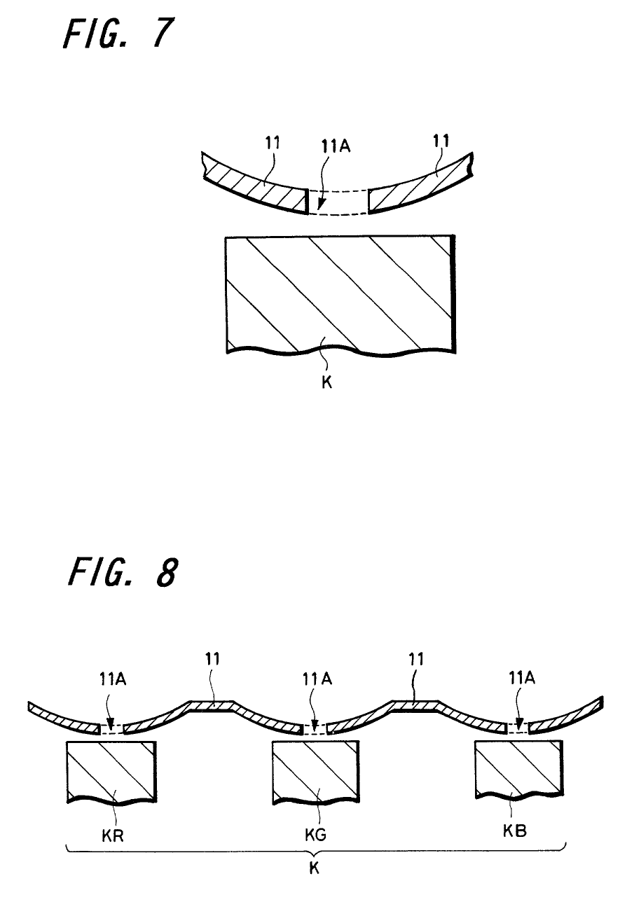

FIG. 7 shows an enlarged cross sectional view of the cathode K area as another embodiment of the present invention.

In this embodiment, by means of forming the first grid 11 in a curved shape, the area around the beam hole 11A of the first grid 11 opposite the cathode K is in closest proximity to the cathode K.

The surface of the cathode K is flat just like a conventional cathode.

For this case, because the area around the beam hole 11A of the first grid 11 is in closest proximity to the cathode K, the center area on the flat surface that forms the electron emission surface of the cathode K that meets the beam hole 11A of the first grid 11 is in closest proximity to the first grid 11.

Therefore, an electric field can be concentrated at this center area making it possible to reduce the working area in the same manner as each embodiment described above.

The composition shown in FIG. 7 is formed in a manner such that each first grid 11 protrudes towards the three cathodes KR, KG and KB as shown in FIG. 8 when an electron gun for use with a color cathode ray tube is, for example, used in the electron gun 10 that has three cathodes K (KR, KG, KB) as shown in FIG. 2.

The present invention is not limited to the embodiments described above and changes in form and details can be made therein without departing from the spirit and scope of the invention.

Having described preferred embodiments of the present invention with reference to the accompanying drawings, it is to be understood that the present invention is not limited to the above-mentioned embodiments and that various changes and modifications can be effected therein by one skilled in the art without departing from the spirit or scope of the present invention as defined in the appended claims.

What is claimed is:

1. An electron gun comprised of a cathode that has an electron emission surface and a first grid that has a beam hole, wherein
said electron emission surface and said beam hole being arranged opposite to each other and
the area opposite said beam hole within said electron emission surface being in closest proximity to said first grid.

2. An electron gun as set forth in claim 1, wherein
said electron emission surface forming a convex surface on said first grid.

3. An electron gun as set forth in claim 2, wherein
said convex surface being a surface formed by a press process.

4. An electron gun as set forth in claim 2, wherein
said convex surface being a surface being a curved surface.

5. An electron gun as set forth in claim 2, wherein
said convex surface being a curved surface with a different curvature depending on the direction.

6. An electron gun as set forth in claim 2, wherein
said convex surface being a paraboloid.

7. An electron gun as set forth in claim 2, wherein
said convex surface being a flat surface.

8. A cathode ray tube equipped with an electron gun, wherein
said electron gun having a cathode that has an electron emission surface and a first grid that has a beam hole and said electron emission surface and said beam hole being arranged opposite to each other and
the area opposite said beam hole within said electron emission surface being in closest proximity to said first grid.

9. A cathode ray tube as set forth in claim 8, wherein
said electron emission surface having a convex surface on said first grid.

10. A cathode ray tube as set forth in claim 9, wherein
said convex surface being a surface formed by a press process.

11. A cathode ray tube as set forth in claim 9, wherein
said convex surface being a curved surface.

12. A cathode ray tube as set forth in claim 9, wherein
said convex surface being a curved surface with a different curvature depending on the direction.

13. A cathode ray tube as set forth in claim 9, wherein
said convex surface being a paraboloid.

14. A cathode ray tube as set forth in claim 9, wherein
said convex surface being a flat surface.

15. An image display device equipped with a cathode ray tube, wherein
said cathode ray tube being equipped with an electron gun,
said electron gun being comprised of a cathode that has an electron emission surface and a first grid that has a beam hole and said electron emission surface and said beam hole being arranged opposite to each other and
the area opposite said beam hole within said electron emission surface being in closest proximity to said first grid.

16. A display device as set forth in claim 15, wherein
said electron emission surface having a convex surface on said first grid.

17. A display device as set forth in claim 16, wherein
said convex surface being a surface formed by a press process.

18. A display device as set forth in claim 16, wherein
said convex surface being a curved surface.

19. A display device as set forth in claim 16, wherein
said convex surface being a curved surface with a different curvature depending on the direction.

20. A display device as set forth in claim 16, wherein
said convex surface being a paraboloid.

21. A display device as set forth in claim 16, wherein
said convex surface being flat surface.
